(19) United States
(12) Patent Application Publication
(10) Pub. No.: US 2011/0236577 A1
(43) Pub. Date: Sep. 29, 2011

(54) Case Printing

(76) Inventors: David Law, Seattle, WA (US); Ryan Mongan, Orange, CA (US); Bryan Lee Hynecek, Redwood City, CA (US); Stephen Reiger Myers, Redwood City, CA (US); Jarrel Weis, San Francisco, CA (US)

(21) Appl. No.: 12/828,983

(22) Filed: Jul. 1, 2010

Related U.S. Application Data
(60) Provisional application No. 61/340,942, filed on Mar. 25, 2010.

(51) Int. Cl. B05D 5/00; B05D 1/36; B05D 3/00

(52) U.S. Cl. 427/256; 427/299

(57) ABSTRACT

This is a process of hydropainting a case, box, container, shell, protector, or holder for an electronic device or communication device. In one example, we describe a method which offers the advantage of eliminating the need to mask the device, and therefore, it reduces the cost of using this printing method to add graphics to the case. One example is based on an over-molded or dual-shot case. The case has a hard external shell manufactured by injection molding. This external shell is then over-molded in key areas with a soft rubber material, to provide a case that cushions the electronics with the rubber, but also provides the hard case protection of the external shell. It also provides excellent printing quality, at a lower cost and production time.

This application is based on a provisional application, Ser. No. 61/340,942, filed in USPTO, directly by the inventors.

### BACKGROUND OF THE INVENTION

One of the embodiments of the invention describes a two-part system for cases used for electronics, such as a cell phones, MP3 players, handheld computers, and handheld GPS units. As these types of electronics become ubiquitous, users are becoming more interested in ways to personalize their electronics. One way to do this is to purchase a case that not only personalizes your device, but also protects it from wear and tear.

Standard cases offer some level of personalization through color, etc, however, for a greater personalization, often, limited runs of cases are created through graphical treatments. Artist series, signature series, and limited edition run cases offer unique graphics, and allow the user to buy a case with a greater level of personalization. Beyond just personalization, users are looking for graphics and unique colors and surface treatments on their cases, as the market for cases becomes more sophisticated.

One of the most prevalent methods to apply graphics to molded parts is a technique called hydropainting (also called hydro-painting, hydro-dipping, hydrodipping, hydroprinting, hydrographics, or water transfer printing). This method of production printing on molded parts is used because it can print onto complex geometries and undercuts, and can provide a wide variety of effects (e.g. photo realistic images, patterns, high gloss, matt, etc). A final finish coat is sometimes applied that adds UV and abrasion resistance.

One of the drawbacks of this method of printing is that the edges of the print are difficult to control and require extra steps and costs to ensure a clean and controlled edge. One method of contending with the edges is to mask the part and remove the mask once the printing process is completed. The uneven edge is removed with the removal of the mask and the remaining graphic edge matches the applied masking, which is easy to control, but time consuming, and therefore, expensive to apply.

The term hydropainting (also called hydro-painting, hydro-dipping, hydrodipping, hydroprinting, hydrographics, or water transfer printing) and its process have been described in the following web sites. It is a currently-used manufacturing process.

http://en.wikipedia.org/wiki/Hydrographics_%28printing%29

http://www.hydro-dip.com/process.htm

However, none of the prior art teaches the invention described below.

### SUMMARY OF THE INVENTION

In one embodiment, we describe a method which offers the advantage of eliminating the need to mask the device, and therefore, it reduces the cost of using this printing method to add graphics to the case.

One of the embodiments for this invention is based on an over-molded or dual-shot case. The case shown in the figures has a hard external shell manufactured by injection molding. This external shell is then over-molded in key areas with a soft rubber material, to provide a case that cushions the electronics with the rubber, but also provides the hard case protection and smooth tactile feel of the external shell.

### BRIEF DESCRIPTION OF THE DRAWINGS

FIG. 1. Standard process for hydropainting case, as an example.

FIG. 2. Standard process for manufacturing two shot over-molded case, as an example.

FIG. 3. The process for manufacturing two shot over-molded case with hydropainting (one less step than a traditional masked operation), as an example.

FIG. 4 (a)-(c). One embodiment of the process, as an example.

FIG. 5 (a)-(c). One embodiment of the process, as an example.

### DETAILED DESCRIPTION OF THE PREFERRED EMBODIMENTS

The main advantage of this case is that hydropainting, or printing on the external shell, is simple and straightforward. The shell does not need to be masked which reduces the cost of the printing process significantly. The secondary over-molding of the external shell with the softer rubber allows any edge imperfections that were not masked, to be covered and therefore hidden by the over-molding. This produces a case that offers cushioning, hard case protection and high graphic style, for the least cost possible, as no extra masking or secondary painting steps are required.

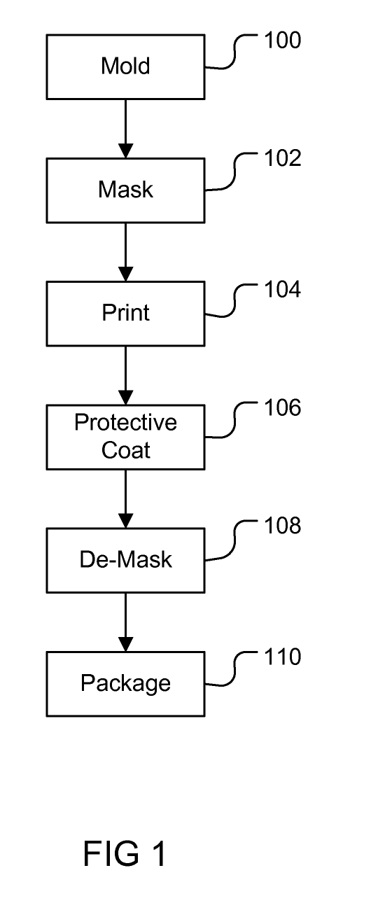

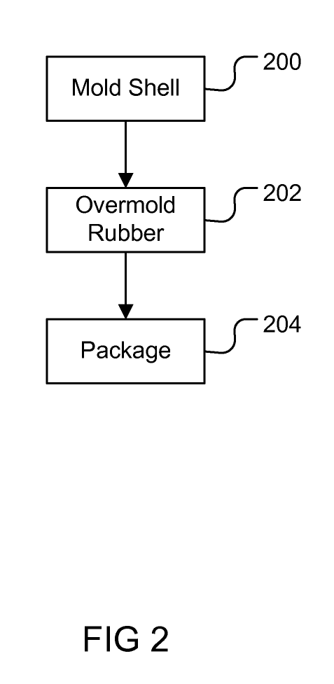

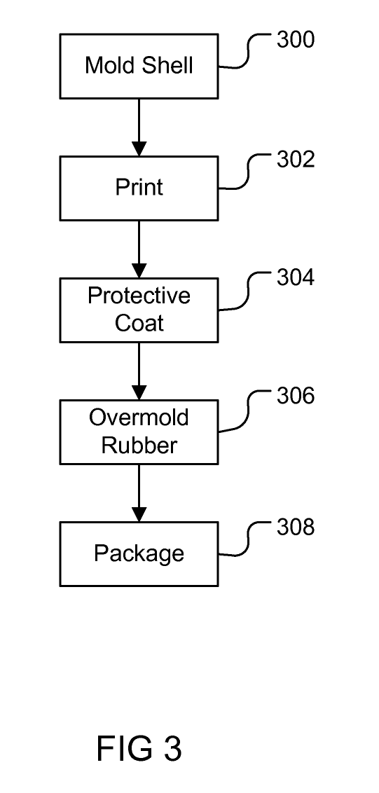

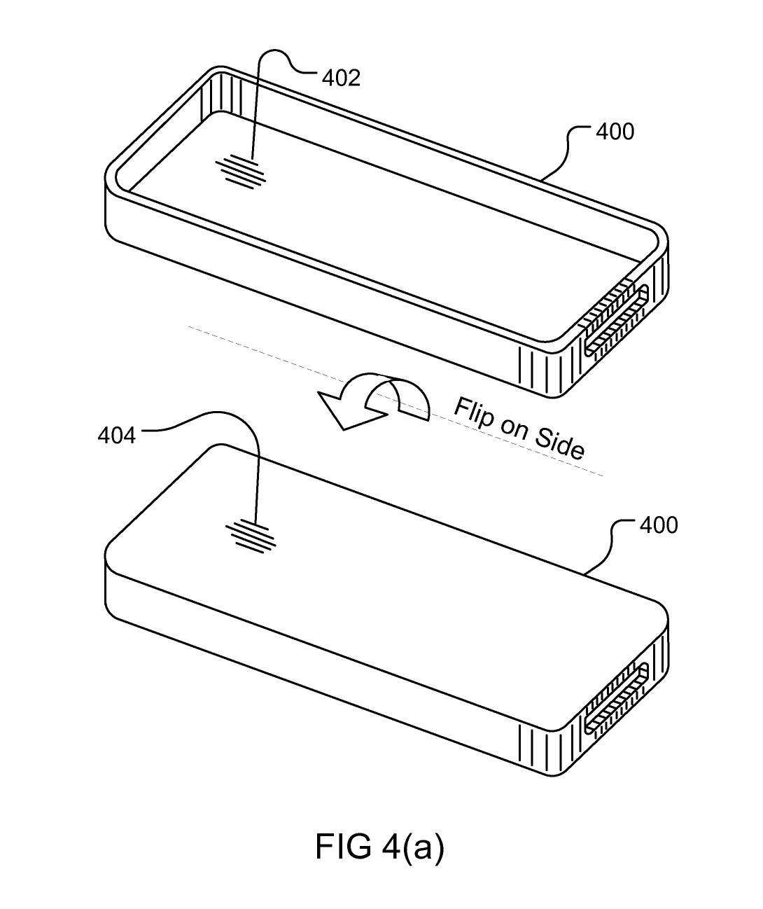

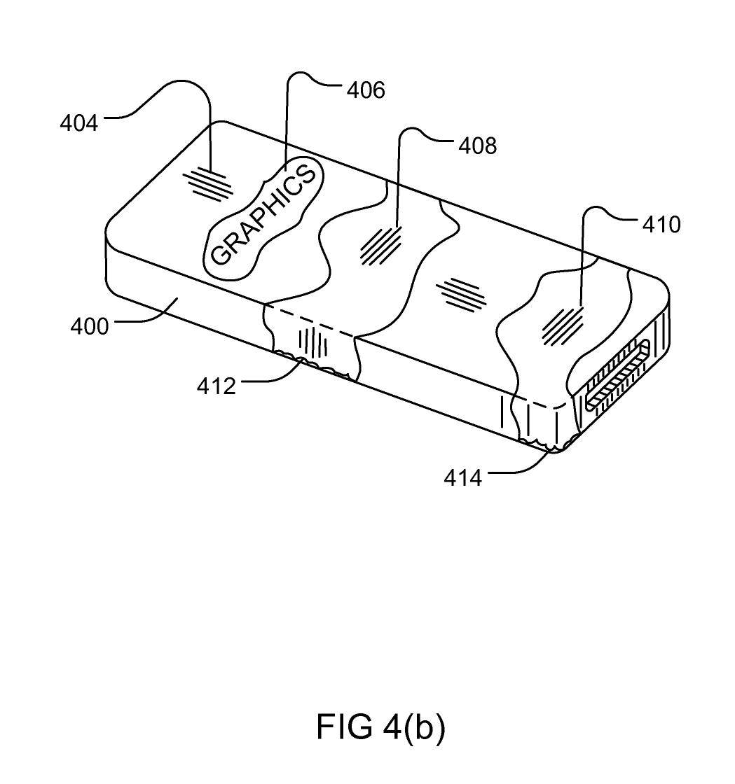

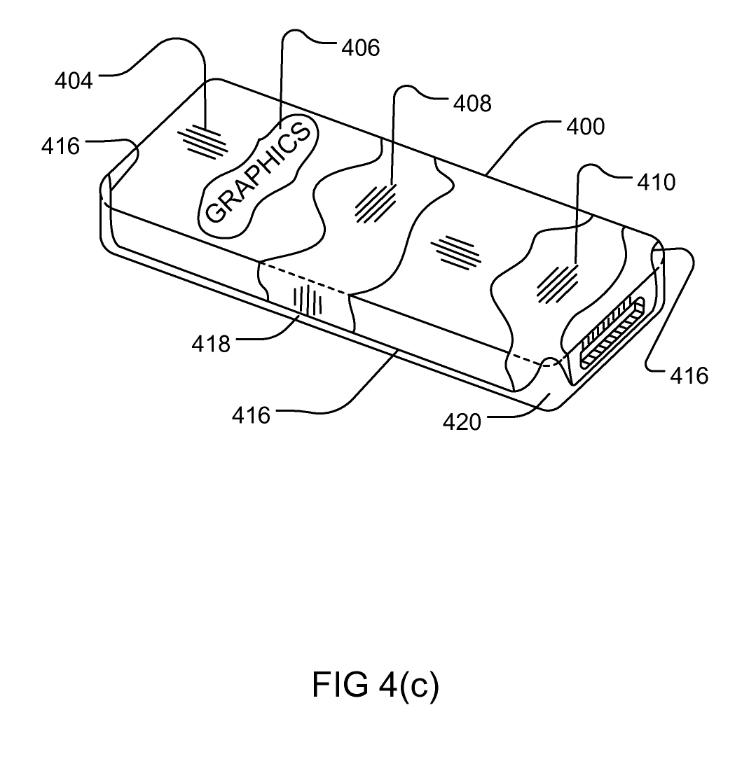

FIG. 1 is the standard process for hydropainting case, as an example. FIG. 2 is the standard process for manufacturing two shot over-molded case, as an example. FIG. 3 is the process for manufacturing two shot over-molded case with hydropainting (one less step than a traditional masked operation), as an example. FIG. 4 (a)-(c) is one embodiment of the process, as an example. FIG. 5 (a)-(c) is also one embodiment of the process, as an example.

FIG. 1 comprises the following steps, as an example: mold 100, mask 102, print (hydropaint) 104, protective coat 106, de-mask 108, and package 110. FIG. 2 comprises the following steps, as an example: mold-shell 200, overmold rubber 202, and package 204. FIG. 3 comprises the following steps, as an example: mold-shell 300, print (hydropaint) 302, protective coat 304, overmold rubber 306, and package 308.

FIG. 4(a) shows the 2 sides of the box or holder, as flipped on one side, with sides 400, inside 402, and outside back 404. FIG. 4(b) shows printing done on the back outside of the box or holder, with sides 400, outside back 404, graphics or text written on it 406, pattern or color 408 and 410, and edge issues and problems at the center 412 and at the corners 414. Corners represent a particularly difficult problem as the graphic stretches down multiple sides and, in so doing, distorts significantly. FIG. 4(c) shows overmold 416, that covers the edges and the uneven termination of the hydropainting, in the middle part 418 and at the corners 420, as shown in FIG. 4(b), versus FIG. 4(c).

The FIG. 4(a) goes through “hydropaint step” to FIG. 4(b), and the FIG. 4(b) goes through “overmold step” to FIG. 4(c), in that order, as the steps of the process, as an example. FIG. 5 mirrors the steps of FIG. 4. As shown in the figures, the overall process is simpler, and cheaper, with a high quality.

The materials used in the molding steps (e.g. items 404 and 416) can be solid, rigid, elastic, plastic, fabric, metal, oil-based, artificial, man-made, natural, mineral, polymer, nylon, or grown-by-humans, for any shape, for any purpose, e.g. for electronic devices, cell phone, or smart phones.

Any variations of the above teaching are also intended to be covered by this patent application.

1. A method of hydropainting a case, box, container, shell, protector, or holder for an electronic device or communication device, said method comprising:
mold shelling an object;
hydropainting said object; and
overmolding said object.

2. The method of hydropainting a case, box, container, shell, protector, or holder for an electronic device or communication device, as recited in claim 1, further comprising:
protective coating said object; and
packaging said object.

3. The method of hydropainting a case, box, container, shell, protector, or holder for an electronic device or communication device, as recited in claim 1, wherein said case, box, container, shell, protector, or holder is rigid.

4. The method of hydropainting a case, box, container, shell, protector, or holder for an electronic device or communication device, as recited in claim 1, wherein said case, box, container, shell, protector, or holder is made of plastic, polymer, or oil-based material.

5. The method of hydropainting a case, box, container, shell, protector, or holder for an electronic device or communication device, as recited in claim 1, wherein said electronic device or communication device is a radio, DVD-player, or CD-player.

6. The method of hydropainting a case, box, container, shell, protector, or holder for an electronic device or communication device, as recited in claim 1, wherein said electronic device or communication device is a camera.

7. The method of hydropainting a case, box, container, shell, protector, or holder for an electronic device or communication device, as recited in claim 1, wherein said electronic device or communication device is a GPS device.

8. The method of hydropainting a case, box, container, shell, protector, or holder for an electronic device or communication device, as recited in claim 1, wherein said electronic device or communication device is a smart phone or a cell phone.

9. The method of hydropainting a case, box, container, shell, protector, or holder for an electronic device or communication device, as recited in claim 1, wherein said electronic device or communication device is a pager.

10. The method of hydropainting a case, box, container, shell, protector, or holder for an electronic device or communication device, as recited in claim 1, wherein said electronic device or communication device is a mobile or satellite phone.

11. The method of hydropainting a case, box, container, shell, protector, or holder for an electronic device or communication device, as recited in claim 1, wherein said electronic device or communication device is a phone or a computer.

12. The method of hydropainting a case, box, container, shell, protector, or holder for an electronic device or communication device, as recited in claim 1, wherein said electronic device or communication device is a walkie talkie.

13. The method of hydropainting a case, box, container, shell, protector, or holder for an electronic device or communication device, as recited in claim 1, wherein said case, box, container, shell, protector, or holder is made of metal, organic material, minerals, baked clay, or stone.

14. The method of hydropainting a case, box, container, shell, protector, or holder for an electronic device or communication device, as recited in claim 1, wherein said case, box, container, shell, protector, or holder is hydropainted different color, shapes, patterns, or designs.

15. The method of hydropainting a case, box, container, shell, protector, or holder for an electronic device or communication device, as recited in claim 1, wherein said case, box, container, shell, protector, or holder is hydropainted or decorated with text, trademarks, logos, poems, or symbols.

16. The method of hydropainting a case, box, container, shell, protector, or holder for an electronic device or communication device, as recited in claim 1, wherein said case, box, container, shell, protector, or holder is laminated with a transparent material.

17. The method of hydropainting a case, box, container, shell, protector, or holder for an electronic device or communication device, as recited in claim 1, wherein said case, box, container, shell, protector, or holder is baked, annealed, or heat treated for a specific cycle, time period, or temperature.

18. The method of hydropainting a case, box, container, shell, protector, or holder for an electronic device or communication device, as recited in claim 1, wherein said case, box, container, shell, protector, or holder has an adjustment mechanism for adjusting size of said case, box, container, shell, protector, or holder.

19. The method of hydropainting a case, box, container, shell, protector, or holder for an electronic device or communication device, as recited in claim 1, wherein said case, box, container, shell, protector, or holder is a non-rigid, elastic, or flexible material.

20. The method of hydropainting a case, box, container, shell, protector, or holder for an electronic device or communication device, as recited in claim 1, wherein said case, box, container, shell, protector, or holder comprises more than one piece or part.
